(19) United States
(12) Patent Application Publication
(10) Pub. No.: US 2019/0308408 A1
(43) Pub. Date: Oct. 10, 2019

(54) PRINTER AND PRINTING SYSTEM

(71) Applicant: Roland DG Corporation, Hamamatsu-shi (JP)

(72) Inventors: Shinya YAMAMOTO, Hamamatsu-shi (JP); Masakazu IGARASHI, Hamamatsu-shi (JP); Kiyomasa IMAIZUMI, Hamamatsu-shi (JP)

(21) Appl. No.: 16/374,817

(22) Filed: Apr. 4, 2019

(30) Foreign Application Priority Data
Apr. 9, 2018 (JP) 2018-074681

(51) Int. Cl. B41J 2/045; B41J 25/308; B41J 11/66

(52) U.S. Cl. CPC B41J 2/04508; B41J 11/663; B41J 25/308; B41J 2/04586

(57) ABSTRACT

Job types include a first job type in which a second process is performed after a first process and a second job type in which the first process is performed and the second process is not performed. In a printer, a recording medium is allowed to be sandwiched by a center pinching roller and driving rollers. A controller of the printer includes a first primary elevation controller that controls the center pinching roller such that the center pinching roller stays down on the driving rollers to hold the recording medium in performing the first process in the first job type and a first secondary elevation controller that controls the center pinching roller to move upward and stay away from the driving rollers in performing the first process in the second job type.

### CROSS REFERENCE TO RELATED APPLICATIONS

This application claims the benefit of priority to Japanese Patent Application No. 2018-074681 filed on Apr. 9, 2018. The entire contents of this application are hereby incorporated herein by reference.

### BACKGROUND OF THE INVENTION

### 1. Field of the Invention

The present disclosure relates to a printer and a printing system.

### 2. Description of the Related Art

A printer with a cutting head known to perform printing on a recording medium such as a recording paper sheet or a resin sheet and then cuts the recording medium in a portion surrounding an image printed on the recording medium. JP 4855510 B, for example, discloses such a printer with a cutting head.

As disclosed in JP 4855510 B, during printing and cutting, the recording medium is moved while being sandwiched between pinching rollers retaining the recording medium and driving rollers disposed below the pinching rollers. The pinching rollers here include a pair of side pinching rollers retaining both end portions of the recording medium and at least one center pinching roller disposed between the pair of side pinching rollers. During printing, the recording medium is sandwiched between the side pinching rollers and the driving rollers and between the center pinching roller and the driving roller, so as to prevent the recording medium from leaving from a placing table on which the recording medium is placed. Accordingly, occurrence a drawback in which image quality varies in the entire recording medium can be suppressed.

In cutting a recording medium subjected to no printing, to reduce a positional shift of the recording medium, the recording medium is preferably conveyed while being sandwiched between the center pinching roller and the driving roller. On the other hand, in cutting the recording medium subjected to printing, the printed recording medium is returned (also referred to as “taken back”) to a printing start position. At this time, if the recording medium is sandwiched between the center pinching roller and the driving roller, the center pinching roller may travel on the printed surface so that a drawback might occur in a printed image. In view of this, in cutting the recording medium subjected to printing, to put a higher priority on image quality, the center pinching roller is preferably lifted so that the recording medium is not sandwiched between the center pinching roller and the driving roller.

Operations of a printer on a recording medium, such as printing and cutting, will be hereinafter referred to as a “process.” A process that is performed alone or a series of processes that are performed in sequence will be hereinafter referred to as a “job.” As described above, even for the same process, the position of the center pinching roller in the vertical direction might be different among different types of jobs (job types). For example, even for the same process of cutting, the position of the center pinching roller in the vertical direction might be different between a job in which cutting is performed after printing and a job in which only cutting is performed.

### SUMMARY OF THE INVENTION

Preferred embodiments of the present disclosure provide printers and printing systems each capable of performing automatic control such that a state of a center pinching roller in a vertical direction is different among different job types even for a same process.

A printer according to an example of the present disclosure includes a placing table, an ink head, a head moving mechanism, a medium moving mechanism, and a controller. A recording medium is placed on the placing table. The ink head discharges ink onto the recording medium placed on the placing table. The head moving mechanism moves the ink head in main scanning directions relative to the recording medium placed on the placing table. The medium moving mechanism moves the recording medium placed on the placing table in sub-scanning directions relative to the ink head. The controller controls the ink head, the head moving mechanism, and the medium moving mechanism. The medium moving mechanism includes a pair of side pinching rollers, at least one center pinching roller, driving rollers, and an elevation mechanism. The side pinching rollers are disposed above the placing table and press end portions of the recording medium in the main scanning direction. The center pinching roller is disposed between the pair of side pinching rollers and presses the recording medium. The driving rollers are arranged in the main scanning direction, are located below the side pinching rollers and the center pinching roller, and move the recording medium in the sub-scanning directions while the recording medium is sandwiched between the driving rollers and the side pinching rollers and between the driving rollers and the center pinching roller. The elevation mechanism lifts and lowers the center pinching roller. The controller includes a storage that stores job data. The job data includes a job command to set basic setting information on printing, and an execution command including at least a first process start command to start a first process on the recording medium. The job command includes a job type command in which one job type is specified from job types including a first job type in which the first process is performed and a second process different from the first process is not performed, and a second job type in which the first process is performed after the second process is performed. The controller includes a command executor, a first primary elevation controller, and a first secondary elevation controller. The command executor executes the job command and the execution command. The first primary elevation controller controls the elevation mechanism such that the center pinching roller stays down on the driving rollers to hold the recording medium (in other words, the center pinching roller and the driving rollers “sandwich” the recording medium) in a case where the job type of the job type command when the job type command is executed by the command executor is the first job type and the first process start command is executed by the command executor. The first secondary elevation controller controls the elevation mechanism such that the center pinching roller moves upward and stays away from the driving rollers in a case where the job type of the job type command when the job type command is executed by the command executor is the second job type and the first process start command is executed by the command executor.

In a printer according to an example embodiment of the present disclosure, a job type to be executed can be recognized before the job is started and after the command executor executes the job type command in which the job type is set. In a case where the first process is performed in the first job type, the center pinching roller is controlled by the first primary elevation controller such that the center pinching roller and the driving roller sandwich the recording medium. On the other hand, in a case where the first process is performed in the second job type, the center pinching roller is controlled by the first secondary elevation controller to move upward and stay away from the driving roller. Thus, by executing the job type command in which the job type is set, the center pinching roller is automatically controlled such that the position of the center pinching roller in the vertical direction is different among the cases where different job types are executed even for execution of the same first process.

According to example embodiments of the present disclosure, automatic control is able to be performed such that the state of the center pinching roller in the vertical direction are different in different job types even for the same process.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a front view of a printer included in a printing system according to a first preferred embodiment of the present invention.

FIG. 2A is a front view of ink jet head and a cutting head.

FIG. 2B is a front view of the ink jet head and the cutting head.

FIG. 3 is a perspective view partially illustrating the printer.

FIG. 4 is a block diagram of the printing system.

FIG. 5 is a view showing an example of job data on a printing and cutting job.

FIG. 6 is a flowchart showing that control of a position of a center pinching roller in the vertical direction differs in cutting a recording medium.

FIG. 7 is a view showing an example of job data on a cutting job.

FIG. 8 is a view showing an example of job data on an overprinting job in a second preferred embodiment of the present invention.

FIG. 9 is a block diagram of a printer according to the second preferred embodiment of the present invention.

FIG. 10 is a flowchart showing that control of a position of a center pinching roller in the vertical direction differs in printing a main layer on a recording medium.

FIG. 11 is a view showing an example of job data of a single-layer printing job.

### DETAILED DESCRIPTION OF THE PREFERRED EMBODIMENTS

Printing systems including printers according to preferred embodiments of the present disclosure and job data creating devices will be described with reference to the drawings. The preferred embodiments described here are, of course, not intended to particularly limit the present disclosure. Members and elements having the same functions are denoted by the same reference characters, and description for the same members and elements will not be repeated or will be simplified as appropriate.

### First Preferred Embodiment

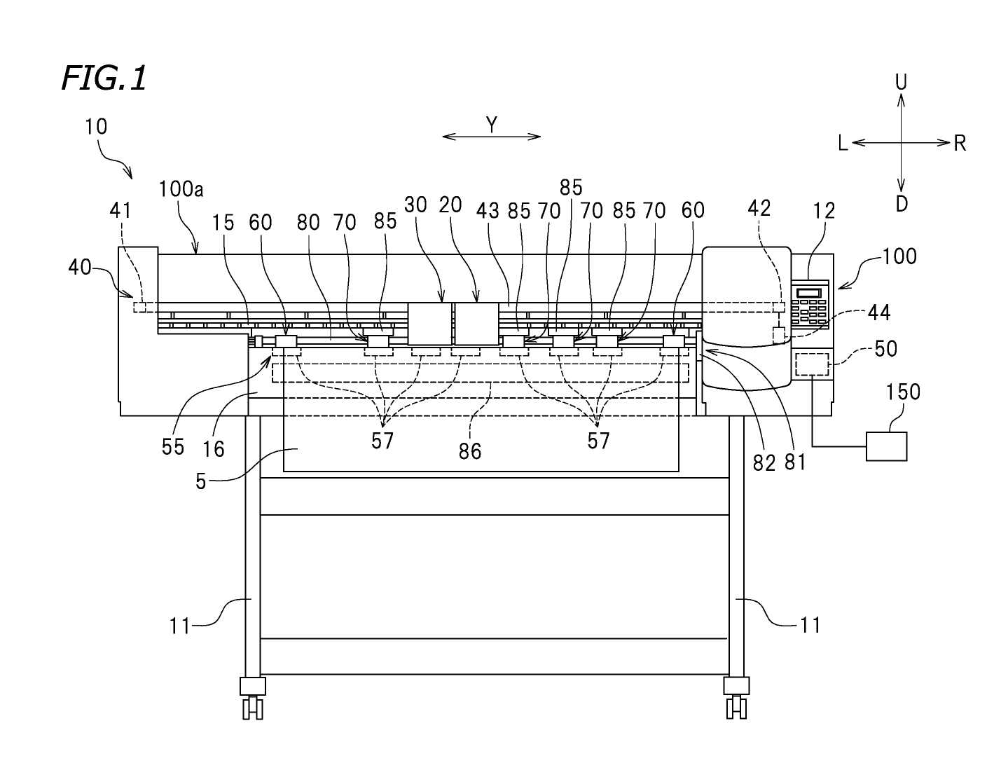

FIG. 1 is a front view of a printer 100 included in a printing system 10 according to a first preferred embodiment of the present invention. As illustrated in FIG. 1, the printing system 10 includes the printer 100, and a job data creating device 150. In the following description, left, right, up, and down respectively refer to left, right, up, and down seen from an operator at the front of the printer 100. The direction away from the printer 100 relative to the operator will be referred to as forward, and the direction toward the printer 100 relative to the operator will be referred to as rearward. Characters F, Rr, L, R, U, and D in the drawings represent front, rear, left, right, up, and down, respectively. Character Y in the drawings represents main scanning directions. In this preferred embodiment, the main scanning directions Y are left-right directions. Character X in the drawings represents sub-scanning directions. The sub-scanning directions X are directions intersecting with the main scanning directions Y (e.g., directions orthogonal to the main scanning directions Y in a plan view). In this preferred embodiment, the sub-scanning directions X are front-rear directions. Character X1 represents a direction of the sub-scanning directions X from an upstream side to a downstream side (a direction from rear to front in this example). The direction X1 is, for example, a direction in which a recording medium 5 is conveyed in printing. Character X2 represents a direction of the sub-scanning directions X from a downstream side to an upstream side (direction from front to rear in this example). The directions described above are, however, only defined for convenience of description, and should not be restrictive.

As illustrated in FIG. 1, the printer 100 according to the present preferred embodiment is an ink jet printer with a cutting head. The printer 100 is a printing and cutting machine capable of performing printing and cutting on the recording medium 5.

The recording medium 5 is, for example, a recording paper sheet. The recording medium 5 is not limited to the recording paper sheet. Examples of the recording medium 5 include sheets made of a resin material such as PVC and polyester, sealing materials defined by a mount and a release film stacked on the mount and coated with an adhesive, metal sheets of, for example, aluminum or iron, glass boards, and wood boards. The term “cutting” or “cut” includes both the case of cutting the entire recording medium 5 in the thickness direction (e.g., the case of cutting both a mount and a release film of a sealing material) and the case of cutting a portion of the recording medium 5 in the thickness direction (e.g., the case of cutting only the release film of the sealing material without cutting the mount of the sealing material).

As illustrated in FIG. 1, the printer 100 includes a printer body 100a, legs 11, an operation panel 12, a platen 16 on which the recording medium 5 is placed, an ink jet head 20, a cutting head 30, a head moving mechanism 40, a medium moving mechanism 55, and a controller 50.

The printer body 100a includes a casing extending in the main scanning directions Y. The legs 11 support the printer body 100a and are disposed on the lower surface of the printer body 100a. The operation panel 12 is disposed on, for example, the front surface of a right side portion of the printer body 100a. The location of the operation panel 12 is not limited to a specific location. The operation panel 12 is used for, for example, operations by an operator concerning printing and cutting. Although not shown, the operation panel 12 includes, for example, a display device to display information on printing, such as a resolution and a thickness of ink, and a status of the printer 100, such as in-printing and in-cutting, and an input device for inputting information on printing and cutting by the operator. The operation panel 12 is controlled by the controller 50.

The platen 16 supports the recording medium 5 in printing on the recording medium 5 and cutting the recording medium 5. The recording medium 5 is placed on the platen 16. Printing on the recording medium 5 and cutting of the recording medium 5 are performed on the platen 16. The platen 16 extends in the main scanning directions Y. The platen 16 is an example of a “placing table”. A guide rail 15 extending in the main scanning directions Y is disposed above the platen 16.

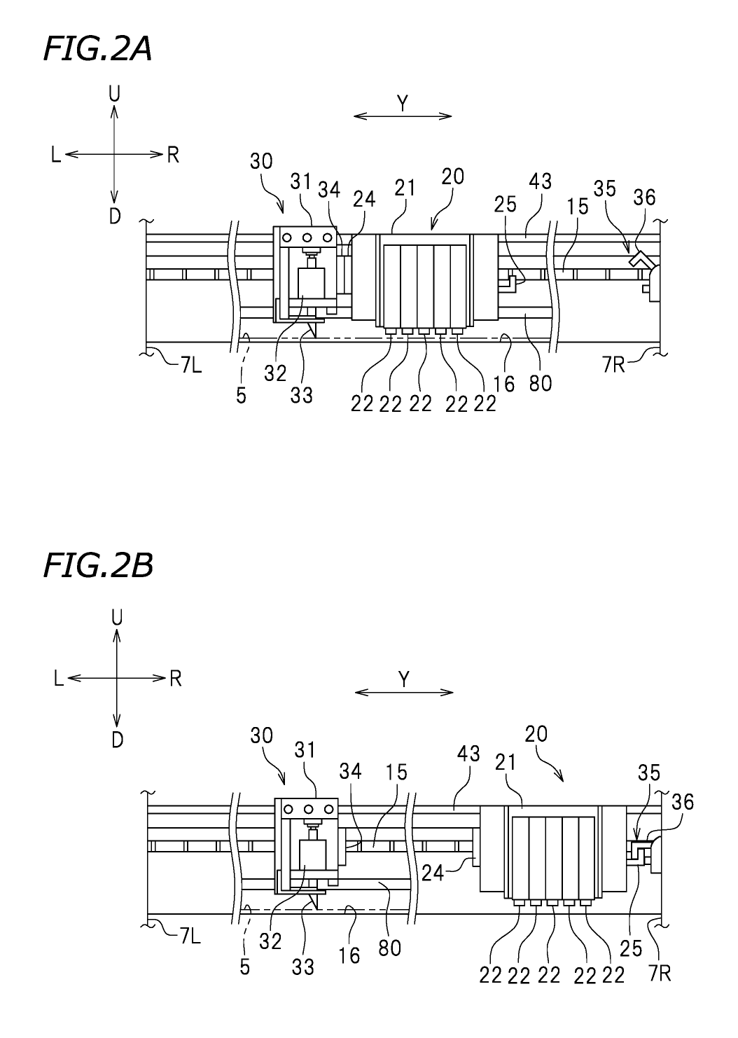

The ink jet head 20 performs printing on the recording medium 5 placed on the platen 16. The ink jet head 20 is movable in the main scanning directions Y. FIGS. 2A and 2B are front views of the ink jet head 20 and the cutting head 30. As illustrated in FIG. 2A, the ink jet head 20 includes a carriage 21 and a plurality of ink heads 22 including a plurality of nozzles (not shown) that discharge ink. In this example, five ink heads 22 are supported by the carriage 21. The five ink heads 22 individually discharge inks with different color tones. For example, each of the ink heads 22 discharges one of process color inks, such as a cyan ink, a magenta ink, a yellow ink, and a black ink, and spot color inks, such as a clear ink and a white ink. The number of the ink heads 22 is not limited to five. Colors of inks discharged from the ink heads 22 are not limited to specific colors. The carriage 21 is supported by the guide rail 15. The carriage 21 is engaged with the guide rail 15 to be movable in the main scanning directions Y.

The cutting head 30 cuts the recording medium 5 placed on the platen 16. The cutting head 30 is movable in the main scanning directions Y. The cutting head 30 includes the carriage 31, a solenoid 32, and a cutter 33. The cutter 33 is attached to the carriage 31 through the solenoid 32. The solenoid 32 is controlled by the controller 50 (see FIG. 1). When the solenoid 32 is turned on/off, the cutter 33 moves upward or downward to contact the recording medium 5 or to move away from the recording medium 5. The carriage 31 is supported by the guide rail 15. The carriage 31 is engaged with the guide rail 15 to be movable in the main scanning directions Y.

As illustrated in FIG. 1, the head moving mechanism 40 is a mechanism that causes the carriage 21 of the ink jet head 20 and the carriage 31 of the cutting head 30 to move in the main scanning directions Y relative to the recording medium 5 placed on the platen 16. The head moving mechanism 40 causes the carriage 21 and the carriage 31 to move in the main scanning directions Y. The configuration of the head moving mechanism 40 is not specifically limited. The head moving mechanism 40 includes a pulley 41, a pulley 42, an endless belt 43, and a carriage motor 44. The pulley 41 is disposed at the left end of the guide rail 15. The pulley 42 is disposed at the right end of the guide rail 15. The belt 43 is wound around the pulley 41 and the pulley 42. The belt 43 is fixed to an upper portion of the rear surface of the carriage 31 (see FIG. 2A). The carriage motor 44 is connected to the right pulley 42. The carriage motor 44 may be connected to the left pulley 41. In this example, the carriage motor 44 is driven to rotate the pulley 42 so that the belt 43 moves between the pulley 41 and the pulley 42. Accordingly, the carriage 31 moves in the main scanning directions Y. The carriage motor 44 is controlled by the controller 50.

As illustrated in FIG. 2A, a coupling member 24 defined by a magnet is disposed at the left of the carriage 21. A coupling member 34 defined by a magnet is fixed to the right side of the carriage 31. The coupling member 24 is detachably coupled to the coupling member 34 of the cutting head 30. In this preferred embodiment, the coupling member 24 and the coupling member 34 use magnetic forces. The coupling member 24 and the coupling member 34 are not limited to members using magnetic forces, and may have other configurations, such as engaging members. An L-shaped bracket 25 is disposed at the right of the carriage 21.

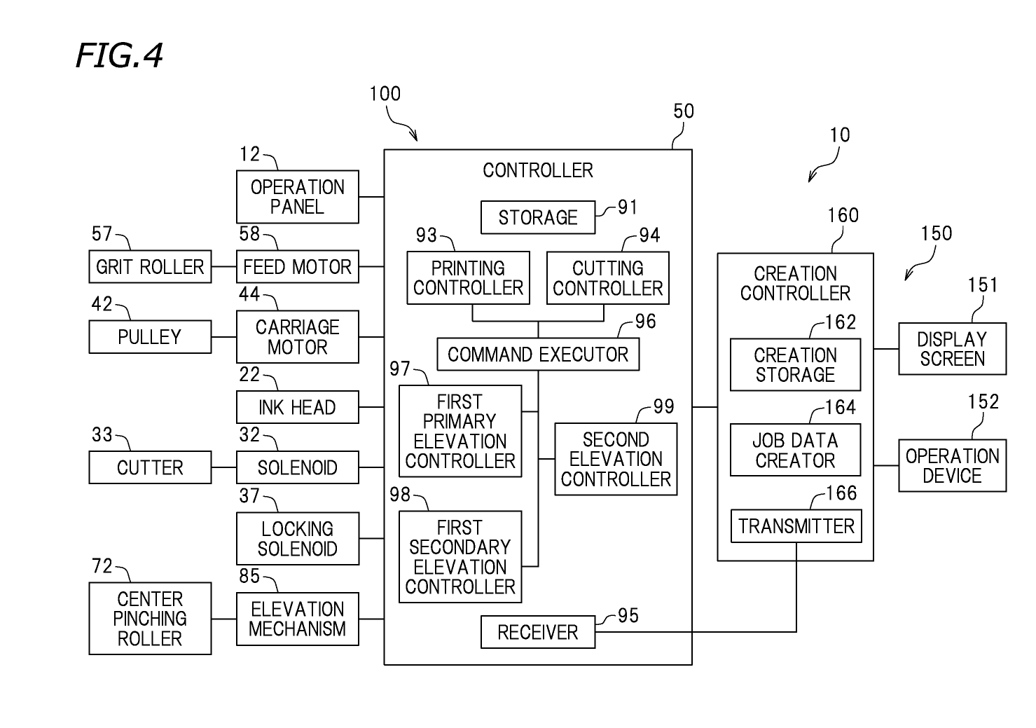

A left side frame 7L and a right side frame 7R are respectively disposed at the left and right of the platen 16. The guide rail 15 is supported by the left side frame 7L and the right side frame 7R. The right side frame 7R is provided with a lock device 35 to lock the ink jet head 20 at a standby position. The lock device 35 includes a bracket 36 to be locked with the bracket 25, and a locking solenoid 37 (see FIG. 4) to cause the bracket 36 to move between a locked position (see FIG. 2B) and an unlocked position (see FIG. 2A). The locking solenoid 37 is controlled by the controller 50.

In printing with the ink jet head 20, the bracket 36 is set at the unlocked position as illustrated in FIG. 2A. When the carriage 31 of the cutting head 30 moves rightward so that the coupling member 34 and the coupling member 24 are brought into contact with each other, the carriage 31 and the carriage 21 are coupled to each other. Consequently, the ink jet head 20 becomes movable in the left-right directions together with the cutting head 30. On the other hand, in cutting with the cutting head 30, the ink jet head 20 is positioned at the standby position, and the bracket 36 of the lock device 35 is set at the locked position, as illustrated in FIG. 2B. Consequently, movement of the ink jet head 20 is prevented. When the carriage 31 moves leftward, the coupling member 34 and the coupling member 24 move away from each other so that coupling between the carriage 31 and the carriage 21 is canceled. Consequently, while the ink jet head 20 is kept at the standby position, the cutting head 30 becomes movable in the left-right directions.

As illustrated in FIG. 1, the medium moving mechanism 55 moves the recording medium 5 placed on the platen 16 in the sub-scanning directions X relative to the ink jet head 20 (i.e., the ink heads 22) and the cutting head 30. In this example, the medium moving mechanism 55 moves the recording medium 5 placed on the platen 16 in the sub-scanning directions X. The medium moving mechanism 55 includes grit rollers 57, a feed motor 58 (see FIG. 4), side pinching roller units 60, center pinching roller units 70, a retention shaft 80, a rotation mechanism 81, and an elevation mechanism 85.

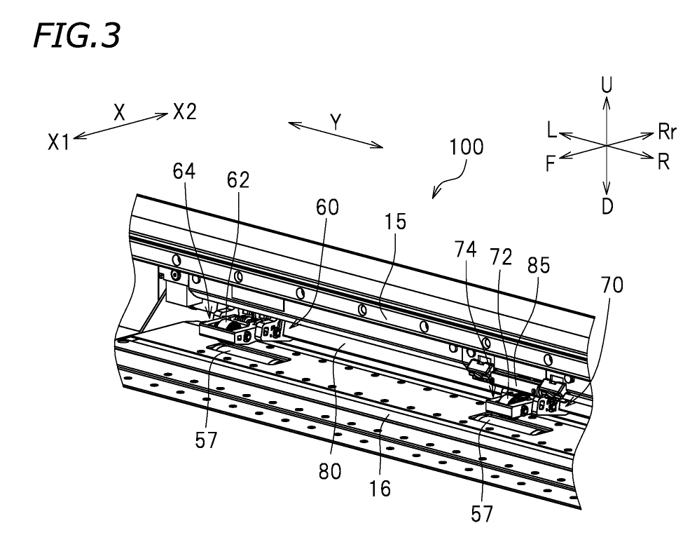

FIG. 3 is a perspective view illustrating a peripheral structure of the platen 16. FIG. 3 shows a left portion of the platen 16. As illustrated in FIG. 3, the grit rollers 57 are disposed on the platen 16. The grit rollers 57 are embedded in the platen 16 such that upper portions of the grit rollers 57 are exposed to the outside. In this preferred embodiment, as illustrated in FIG. 1, the number of the grit rollers 57 is eight, for example. However, the number of the grit rollers 57 is not limited to a specific number. The grit rollers 57 are an example of a “driving roller”. The grit rollers 57 are arranged in parallel with the main scanning directions Y. As illustrated in FIG. 3, some of the grit rollers 57 are disposed below side pinching rollers 62 described later. Some of the grit rollers 57 and the side pinching rollers 62 sandwich the recording medium 5. The other grit rollers 57 are disposed below center pinching rollers 72 described later. The other grit rollers 57 and the center pinching rollers 72 sandwich the recording medium 5. The feed motor 58 (see FIG. 4) is connected to the grit rollers 57. The feed motor 58 is controlled by the controller 50. With the recording medium 5 sandwiched between the grit rollers 57 and the side pinching rollers 62 and between the grit rollers 57 and the center pinching rollers 72, the feed motor 58 is driven to rotate the grit rollers 57. Accordingly, the recording medium 5 is conveyed in the sub-scanning directions X. In this preferred embodiment, with the recording medium 5 sandwiched between the grit rollers 57 and the side pinching rollers 62 and between the grit rollers 57 and the center pinching rollers 72, for example, the recording medium 5 is conveyed from an upstream side to a downstream side, that is, in the direction X1 of the sub-scanning directions X. On the other hand, with the recording medium 5 sandwiched between the grit rollers 57 and the side pinching rollers 62, the recording medium 5 is conveyed from the downstream side to the upstream side, that is, in the direction X2 of the sub-scanning directions X.

The side pinching roller units 60 are disposed above the platen 16. In this preferred embodiment, as illustrated in FIG. 1, the printer 100 includes a pair of left and right side pinching roller units 60. The left side pinching roller unit 60 is disposed above a left end portion of the platen 16. The right side pinching roller unit 60 is disposed above a right end portion of the platen 16. The side pinching roller units 60 are arranged in parallel with the main scanning directions Y. As illustrated in FIG. 3, each of the side pinching roller units 60 includes the side pinching roller 62 and a first retention member 64. The side pinching rollers 62 press an end portion of the recording medium 5 from above. The side pinching rollers 62 are disposed above the grit rollers 57 to face the grit rollers 57. The side pinching rollers 62 are made of, for example, rubber. The first retention member 64 rotatably supports the side pinching roller 62. The first retention member 64 supports the side pinching roller 62 such that the side pinching roller 62 is movable upward and downward.

The center pinching roller units 70 are disposed above the platen 16. The center pinching roller units 70 are disposed between the pair of side pinching roller units 60 and 60. In this preferred embodiment, the printer 100 includes six center pinching roller units 70, for example. FIG. 1 shows four of the center pinching roller units 70, and does not show two of the center pinching roller units 70. The number of the center pinching roller units 70 is not limited to a specific number. The center pinching roller units 70 are arranged in parallel with the main scanning directions Y. Each of the center pinching roller units 70 includes the center pinching roller 72 and a second retention member 74. The center pinching rollers 72 press the recording medium 5 from above. As illustrated in FIG. 3, the center pinching rollers 72 are disposed above the grit rollers 57 to face the grit rollers 57. The center pinching rollers 72 are made of, for example, rubber. The second retention member 74 rotatably supports the center pinching roller 72. The second retention member 74 supports the center pinching roller 72 such that the center pinching roller 72 is movable upward and downward.

As illustrated in FIG. 1, the retention shaft 80 extends in the main scanning directions Y. The retention shaft 80 is disposed below the guide rail 15 and above the platen 16. The retention shaft 80 retains the side pinching roller units 60 and the center pinching roller units 70. The side pinching roller units 60 and the center pinching roller units 70 are slidable with respect to the retention shaft 80 so that attachment positions are changeable in the main scanning directions Y.

The rotation mechanism 81 is disposed at the right of the platen 16. The rotation mechanism 81 rotates the retention shaft 80 about the center axis of the retention shaft 80. The configuration of the rotation mechanism 81 is not specifically limited. For example, the rotation mechanism 81 includes a lever 82 connected to the right end of the retention shaft 80 through an unillustrated link mechanism. The lever 82 can be pushed down and pushed up. When the operator pushes the lever 82 downward, the retention shaft 80 is caused to rotate so that the side pinching rollers 62 and the center pinching rollers 72 approach the grit rollers 57. On the other hand, when the operator pushes the lever 82 upward, the retention shaft 80 is caused to rotate so that the side pinching rollers 62 and the center pinching rollers 72 move upward and stay away from the grit rollers 57.

The elevation mechanism 85 lifts and lowers the center pinching rollers 72 relative to the platen 16. In this example, the elevation mechanism 85 is configured to lift and lower a plurality of center pinching rollers 72 at the same time. The configuration of the elevation mechanism 85 is not specifically limited. For example, although not shown, the elevation mechanism 85 includes a coupling member coupling the plurality of center pinching roller units 70, and a driving motor that is connected to the coupling member through the link mechanism and moves the coupling member upward and downward.

In this preferred embodiment, as illustrated in FIG. 1, the printer 100 includes a heater 86. The heater 86 is disposed below the platen 16. The heater 86 heats the platen 16. By heating the platen 16, the recording medium 5 placed on the platen 16 is heated.

The controller 50 will now be described. FIG. 4 is a block diagram of the printing system 10. The controller 50 is a device that controls printing on the recording medium 5 and cutting of the recording medium 5. The configuration of the controller 50 is not specifically limited. The controller 50 is, for example, a microcomputer. A hardware architecture of the microcomputer is not limited to a specific architecture, and includes an I/F, a CPU, a ROM, a RAM, a memory device, and so forth. As illustrated in FIG. 1, the controller 50 is disposed inside the printer body 100a. However, the controller 50 is not necessarily disposed inside the printer body 100a. For example, the controller 50 may be a computer or the like disposed outside the printer body 100a. In this case, the controller 50 is communicably connected to the printer body 100a by wires or wirelessly.

As illustrated in FIG. 4, the controller 50 controls driving of the carriage motor 44 to control rotation of the pulley 42 and traveling of the belt 43 (see FIG. 1). Accordingly, the controller 50 controls movement of the ink jet head 20 and the cutting head 30 in the main scanning directions Y. The controller 50 controls driving of the feed motor 58 to control rotation of the grit rollers 57. Accordingly, the controller 50 controls movement of the recording medium 5 placed on the platen 16 in the sub-scanning directions X. The controller 50 controls the timing and amount of discharge of ink from the ink heads 22, for example. The controller 50 controls the solenoid 32 to control upward and downward movement of the cutter 33 and the pressure of the cutter 33. The controller 50 controls the elevation mechanism 85 to control lifting and lowering of the center pinching rollers 72.

In this preferred embodiment, the controller 50 includes a storage 91, a printing controller 93, and a cutting controller 94. The functions of these elements of the controller 50 may be constituted by software or hardware. The functions of these elements of the controller 50 may be implemented by processors or circuits. In the case where the functions of these elements of the controller 50 are implemented by processors, each function of these elements of the controller 50 may be implemented by one processor or a plurality of processors. The functions of these elements of the controller 50 will be described in detail later.

The foregoing description is directed to the configuration of the printer 100 according to the present preferred embodiment. Next, operations of the side pinching roller units 60 and the center pinching roller units 70 will be briefly described. An operation in performing printing on the recording medium 5 and then cutting the recording medium 5 will now be described briefly. In placing the recording medium 5 on the platen 16, the side pinching rollers 62 and the center pinching rollers 72 are separated from the grit rollers 57. When the positioning of the recording medium 5 to the platen 16 is completed, the operator pushes the lever 82 downward. Accordingly, the retention shaft 80 rotates so that the side pinching rollers 62 and the center pinching rollers 72 approach the grit rollers 57. This causes the recording medium 5 to be sandwiched between the side pinching rollers 62 and the grit rollers 57 and between the center pinching rollers 72 and the grit rollers 57. Thereafter, the ink jet head 20 performs printing on the recording medium 5 placed on the platen 16, for example. At this time, the grit rollers 57 rotate to cause the recording medium 5 to move from the upstream side to the downstream side (i.e., in the direction X1).

When the printing is completed, the recording medium 5 is moved from the downstream side to the upstream side (i.e., the direction X2) in order to cut the recording medium 5. At this time, if the recording medium 5 is moved from the downstream side to the upstream side while being sandwiched between the center pinching rollers 72 and the grit rollers 57, the center pinching rollers 72 move on a printed image, which might affect image quality. To prevent this, the controller 50 controls the elevation mechanism 85 so that the center pinching rollers 72 move upward and stay away from the grit rollers 57. At this time, since the side pinching rollers 62 do not move upward, the recording medium 5 is still sandwiched between the side pinching rollers 62 and the grit rollers 57. Subsequently, the controller 50 drives the grit rollers 57 to move the recording medium 5 from the downstream side to the upstream side and starts cutting of the recording medium 5. When cutting of the recording medium 5 is then completed, the operator pushes the lever 82 upward. Accordingly, the retention shaft 80 rotates so that the side pinching rollers 62 move upward and stay away from the grit rollers 57, and the recording medium 5 is able to be removed from the platen 16.

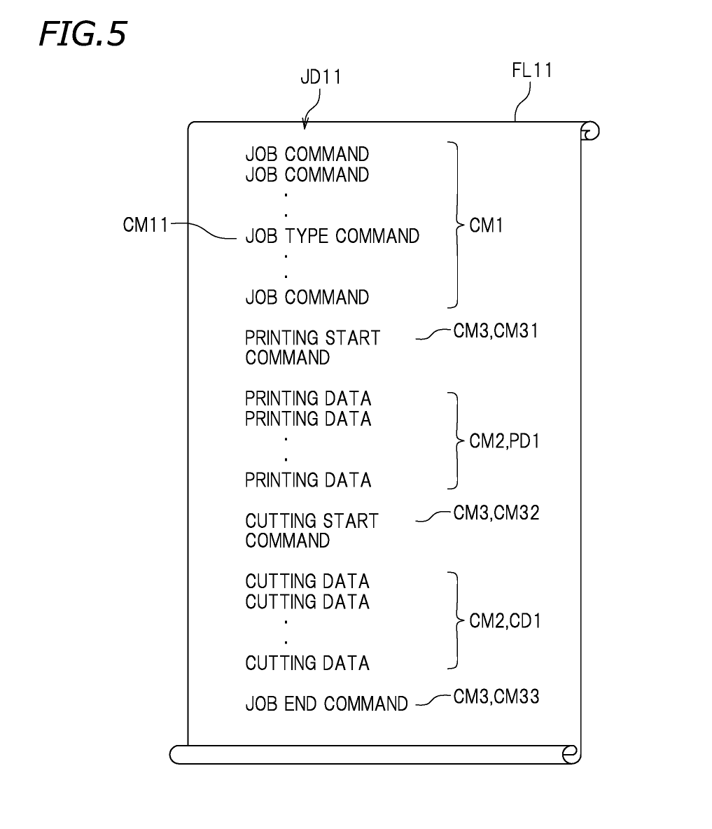

FIG. 5 is a view showing an example of job data JD11. The job data JD11 shown in FIG. 5 is data on a printing and cutting job described later. In the printer 100 according to the present preferred embodiment, a plurality of commands are executed so that settings, printing on the recording medium 5, and cutting of the recording medium 5 are performed. In this example, as shown in FIG. 5, the commands include job commands CM1, control commands CM2, and execution commands CM3.

Operations of the printer 100 on the recording medium 5, such as printing and cutting, will be hereinafter referred to as “processes.” In this example, cutting corresponds to a “first process”, and printing corresponds to a “second process”. In this example, a process that is performed alone or a series of processes that are performed in sequence will be referred to as a “job.” One job is a control defined by the execution command CM3 described later, and a control of the printer 100 from start of execution of a single process or a series of processes to end thereof. The type of a job will be referred to as a “job type.”

The job commands CM1 are commands to set, for example, basic setting information. The job commands CM1 are so-called printer job language (PJL) commands. The basic setting information is information set in the printer 100, and is basic information on printing and cutting. Examples of the basic setting information include the type of the recording medium 5, a resolution, a moving speed of the ink heads 22, and a conveyance speed of the recording medium 5.

The printer 100 according to the present preferred embodiment is a printer with a cutting head as described above, and is capable of performing cutting and printing on the recording medium 5. Examples of the job type here include three jobs: a printing job, a cutting job, and a printing and cutting job. The printing job is a job in which printing is performed and cutting is not performed on the recording medium 5. The cutting job is a job in which printing is not performed and cutting is performed on the recording medium 5. The printing and cutting job is a job in which printing is performed on the recording medium 5 and cutting is performed on the printed recording medium 5. The job types may include other job types in addition to the three job types described above. In this preferred embodiment, the printing and cutting job corresponds to a “second job type”. The cutting job corresponds to a “first job type”. The printing job corresponds to a “third job type”.

The control commands CM2 are commands to specify printing data PD1 in printing and cutting data CD1 in cutting. The printing data PD1 here is specified in printing, and is a path specified by image data to be printed and values such as coordinates. In this example, the control command CM2 for the printing data PD1 will be referred to as a printing control command. The cutting data CD1 is specified in cutting, and is a path in cutting, and a path specified by values such as coordinates (hereinafter also referred to as a cutting path). In this example, the control command CM2 for the cutting data CD1 will be referred to as a cutting control command. The printer 100 executes the control commands CM2 sequentially to perform printing and cutting on the recording medium 5.

The execution commands CM3 are commands to specify a start of a process and end of a job. In this preferred embodiment, the execution commands CM3 are commands to specify a start and an end of printing and commands to specify a start and an end of cutting. The printer 100 executes the execution commands CM3 to recognize start of a process and end of a job, and in this example, a start and an end of each of printing and cutting. The types of the execution commands CM3 are not limited to specific types. In this preferred embodiment, the execution commands CM3 include a printing start command CM31 to start printing, a cutting start command CM32 to start cutting, and a job end command CM33. The job end command CM33 is a command to notify that a job as a series of printing or cutting processes is finished. The printing start command CM31 here is a command specified before the control commands CM2 including the printing data PD1 (printing control command in this example). The printing start command CM31 is an example of a “second process start command”. The cutting start command CM32 is a command specified before the control commands CM2 including the cutting data CD1 (cutting control command in this example). The cutting start command CM32 is an example of a “first process start command”. The job end command CM33 is a command specified when one job is finished. In other words, the job end command CM33 is a command specified in a later stage of the job data JD.

In this preferred embodiment, a series of commands in which the job commands CM1, the control commands CM2, and the execution commands CM3 are sequentially specified in the order of processes as appropriate will be referred to as job data JD11. In the job data JD11, a plurality of job commands CM1 are first set, and then, the control commands CM2 and the execution commands CM3 are set as appropriate. In this example, a file containing the job data JD11 will be referred to as a job execution file FL11.

In this preferred embodiment, even in a case where the job types are different, the printer 100 is able to perform different operations even in executing the same execution commands CM3. For example, in the cutting job, only cutting is performed on the recording medium 5. In the cutting job, the recording medium 5 is preferably pressed toward the platen 16 (see FIG. 3) by the center pinching rollers 72 (see FIG. 3). Accordingly, the recording medium 5 is not easily displaced from the platen 16, and thus, the recording medium 5 is able to be cut more appropriately. Thus, when the cutting start command CM32 is executed as the execution command CM3 in the cutting job, the center pinching rollers 72 are preferably controlled to press the recording medium 5.

On the other hand, in the printing and cutting job, cutting is performed on the printed recording medium 5. In this example, since cutting of the recording medium 5 is performed immediately after printing, ink discharged onto the recording medium 5 has not been dried yet in some cases. In this state, when the recording medium 5 is pressed by the center pinching rollers 72, the ink discharged onto the recording medium 5 might adhere to the center pinching rollers 72. This might degrade printing quality (or image quality) of the recording medium 5. Thus, when the cutting start command CM32 is executed as the execution command CM3 in the printing and cutting job, to place priority on image quality, the recording medium 5 is controlled not to be pressed by the center pinching rollers 72, that is, the center pinching rollers 72 are controlled to be separated from the recording medium 5.

As described above, between the cutting job and the printing and cutting job, for example, positions of the center pinching rollers 72 in the vertical direction when the cutting start command CM32 is executed as the execution command CM3 are preferably different. For example, in starting one job, the printer 100 recognizes which job type is to be performed. Accordingly, even in the case of executing the same execution command CM3, different operations are able to be performed for different job types.

In view of this, in this preferred embodiment, the basic setting information includes a job type. As illustrated in FIG. 5, as the job command CM1, a job type command CM11 to set a job type is used. Execution of the job type command CM11 enables the printer 100 to recognize which job type is to be started at the start of one job. Specifically, in this preferred embodiment, execution of the job type command CM11 enables the printer 100 to recognize which one of the printing job, the cutting job, and the printing and cutting job is now to be performed.

In this preferred embodiment, the job data JD11 including the job commands CM1, the control commands CM2, and the execution commands CM3 is created by a job data creating device 150 (see FIG. 4). The job data creating device 150 will now be described. In this preferred embodiment, as illustrated in FIG. 1, the job data creating device 150 is implemented by a computer disposed outside the printer body 100a of the printer 100. The computer that implements the job data creating device 150 may be a computer dedicated to the printer 100 or a general-purpose computer. The job data creating device 150 may be disposed inside the printer body 100a. As illustrated in FIG. 4, the job data creating device 150 includes a display screen 151, an operation device 152, and a creation controller 160.

The display screen 151 displays, for example, basic setting information such as a job type, printing image data to be printed, cutting image data to specify a shape or the like for cutting. The printing image data is, for example, data of an image to be printed. The cutting image data is, for example, image data showing a location of cutting. The printing image data and the cutting image data are stored in a creation storage 162 described later. The type of the display screen 151 is not limited to a specific type. For example, the display screen 151 is a computer display screen. The display screen 151 may be disposed on the operation panel 12 (see FIG. 1). For example, the display screen 151 may be the display device of the operation panel 12 described above.

The operation device 152 is used by an operator to input or specify the basic setting information, the printing image data, and the cutting image data. For example, the operator can specify a job type of the basic setting information by operating the operation device 152. The type of the operation device 152 is not limited to a specific type. For example, the operation device 152 is a keyboard and a mouse of a computer. The operation device 152 may be a touch panel disposed on the display screen 151. The operation device 152 may be disposed on the operation panel 12. For example, the operation device 152 may be the input device of the operation panel 12 described above. The basic setting information input from the operation device 152 and displayed on the display screen 151 is stored in the creation storage 162.

In this preferred embodiment, the creation controller 160 is, for example, a device that creates the job data JD11 (see FIG. 5) and transmits the created job data JD11 to the controller of the printer 100. The configuration of the creation controller 160 is not limited to a specific configuration. The creation controller 160 is, for example, a microcomputer. A hardware architecture of the microcomputer is not limited to a specific architecture, and includes an interface (I/F) to receive data and the like from external equipment such as a host computer, a CPU, a ROM, a RAM, a memory device, and so forth.

The creation controller 160 is communicably connected to the controller 50 of the printer 100 by wires or wirelessly. The creation controller 160 is communicably connected to the display screen 151 and the operation device 152.

In this preferred embodiment, the creation controller 160 includes the creation storage 162, a job data creator 164, and a transmitter 166. Each function of these elements of the creation controller 160 may be implemented by software or hardware. For example, each function of these elements of the creation controller 160 may be performed by a processor or may be incorporated in a circuit.

The creation storage 162 previously stores printing image data and cutting image data, for example. The creation storage 162 stores basic setting information displayed on the display screen 151 and input from the operation device 152. The job data creator 164 creates the job data JD11 that is data of a job to be executed next. For example, as illustrated in FIG. 5, the job data creator 164 creates job commands CM1, control commands CM2, and execution commands CM3 in conformity with specific formats, based on the basic setting information, the printing image data, and the cutting image data displayed on the display screen 151 and stored in the creation storage 162. For example, the printing data PD1 of the control command CM2 is created from the printing image data. The cutting data CD1 of the control command CM2 is created from the cutting image data. Based on the job type to be executed, the job data creator 164 appropriately arranges the job commands CM1, the control commands CM2, and the execution commands CM3 created by the job data creator 164 to create job data JD11. For example, in the job data JD11 on the printing and cutting job, as illustrated in FIG. 5, the job commands CM1, the printing start command CM31 of the execution command CM3, the control commands CM2 for the printing data PD1, the cutting start command CM32 of the execution command CM3, the control commands CM2 for the cutting data CD1, and the job end command CM33 of the execution command CM3 are arranged in this order. The job data JD11 created by the job data creator 164 is stored in the job execution file FL11. The job execution file FL11 is stored in the creation storage 162.

The transmitter 166 transmits the job data JD11 created by the job data creator 164 to the controller 50 of the printer 100. In this example, the transmitter 166 transmits the job execution file FL11 stored in the creation storage 162 to the controller 50 to transmit the job data JD11 to be executed by the printer 100 to the controller 50.

As illustrated in FIG. 4, the controller 50 of the printer 100 further includes a receiver 95, a command executor 96, a first primary elevation controller 97, a first secondary elevation controller 98, and a second elevation controller 99. The receiver 95 receives the job execution file FL11 sent by the transmitter 166 to receive the job data JD11. The receiver 95 causes the storage 91 to store the job data JD11 received by the receiver 95.

After receiving the job data JD11, the command executor sequentially executes the commands in the job data JD11 to execute a job on the recording medium 5. For example, the command executor 96 executes the job commands CM1 (see FIG. 5) to set, in the printer 100, the basic setting information such as the job type, the type of the recording medium 5, a resolution, the moving speed of the ink heads 22, and the conveyance speed of the recording medium 5. The command executor 96 executes the job type command CM11 to set the job type in the printer 100. For example, the command executor 96 executes the job type command CM11 to set the job type at the printing and cutting job to set the printing and cutting job to the printer 100. Here, the term “setting the basic setting information” means causing the storage 91 to store the basic setting information executed by the job commands CM1, for example.

For example, the command executor 96 executes the printing start command CM31 (see FIG. 5) of the execution command CM3. At this time, the printing controller 93 performs control concerning printing, based on the control commands CM2 for the printing data PD1 subsequent to the printing start command CM31. In this example, the printing controller 93 drives the carriage motor 44 (see FIG. 4) based on the printing data PD1 of the control commands CM2 to cause the ink heads 22 to discharge ink while moving the ink heads 22 in the main scanning directions Y. In this manner, printing in one scanning line is performed. When the movement of the ink heads 22 in the main scanning directions Y is finished, the medium moving mechanism 55 drives the feed motor 58 (see FIG. 4) to convey the recording medium 5 in the sub-scanning directions X to a position of the next scanning line. When the conveyance of the recording medium 5 in the sub-scanning directions X is finished, the printing controller 93 drives the carriage motor 44 again and drives the ink heads 22, and performs printing in the next scanning line. Subsequently, similar operations are repeated until printing is finished. In this preferred embodiment, while printing is performed on the recording medium 5, the recording medium 5 is pressed by the side pinching rollers 62 and the center pinching rollers 72.

For example, the command executor 96 executes the cutting start command CM32 (see FIG. 5) of the execution command CM3. At this time, the cutting controller 94 controls the cutting head 30 based on the control commands CM2 for the cutting data CD1 subsequent to the cutting start command CM32. In this example, based on the cutting data CD1 of the control commands CM2, the cutting controller 94 drives the carriage motor 44 and also drives the feed motor 58 to move the cutting head 30 in two dimensions relative to the recording medium 5. When the solenoid 32 is turned on, the cutter 33 (see FIG. 2A) is lowered so that the cutter 33 is able to be pressed against the recording medium 5. While the cutter 33 is pressed against the recording medium 5, the cutting head 30 is moved relative to the recording medium 5 so that the recording medium 5 is cut.

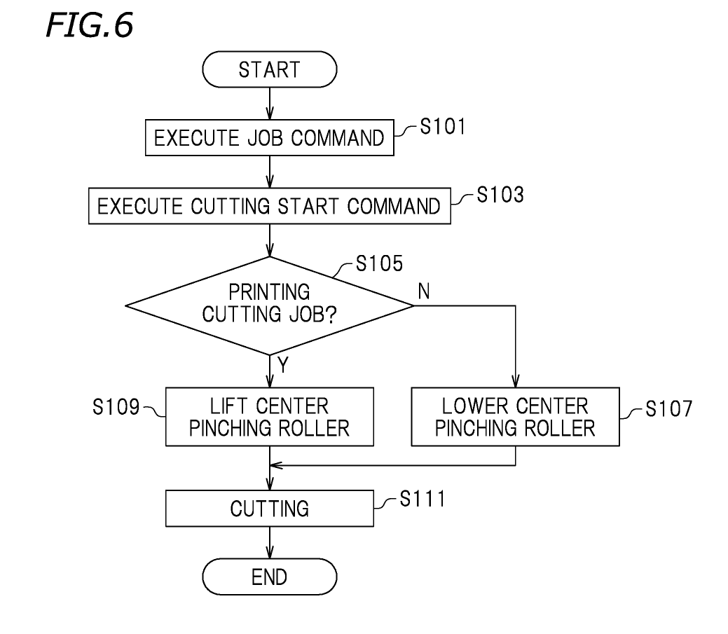

Next, description will be given on an operation in which control of the position of the center pinching rollers 72 in the vertical direction in cutting the recording medium 5 is different for different job types, with reference to the flowchart of FIG. 6.

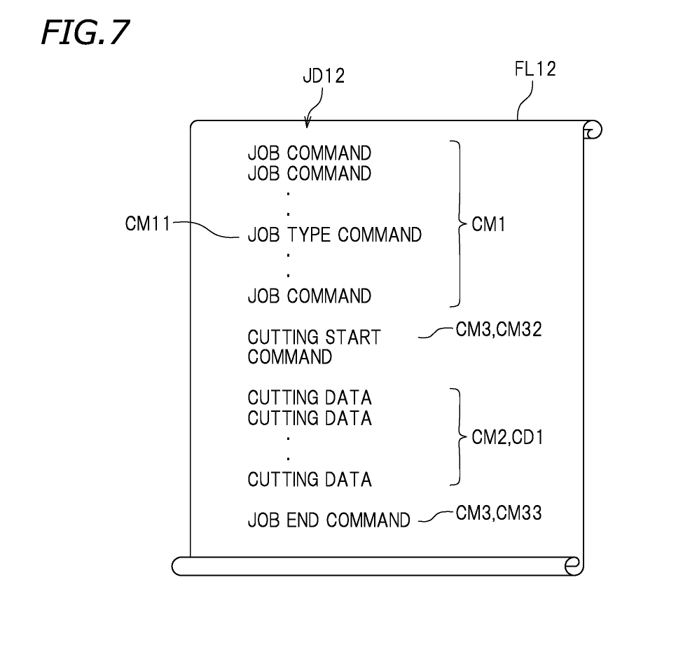

Here, first, a case where the job type is the cutting job will be described. FIG. 7 is a view showing an example of the job data JD12 on the cutting job. As shown in FIG. 7, in the job data JD12 on the cutting job, the job commands CM1 including the job type command CM11 in which the job type is set at the cutting job, the cutting start command CM32 of the execution command CM3, the control commands CM2 for a plurality of pieces of cutting data CD1, and the job end command CM33 of the execution command CM3 are arranged in this order. The job data JD12 is stored in the job execution file FL12.

In executing the job data JD12 on the cutting job, in step S101 of FIG. 6, the command executor 96 sequentially executes the job commands CM1. Accordingly, the storage 91 stores the basic setting information including information indicating that the job type is the cutting job.

Thereafter, in step S103, the command executor 96 executes the cutting start command CM32. Accordingly, the printer 100 recognizes that cutting is performed on the recording medium 5, and performs a process concerning cutting. In this example, since the job type is the cutting job, the process of step S105 proceeds to NO, and step S107 is then performed.

In step S107, the first primary elevation controller 97 controls the elevation mechanism 85 such that the center pinching rollers 72 and the grit rollers 57 sandwich the recording medium 5 placed on the platen 16. In this example, before the cutting job is started, the center pinching rollers 72 have been lowered and the center pinching rollers 72 and the grit rollers 57 sandwich the recording medium 5. Thus, the first primary elevation controller 97 controls the elevation mechanism 85 such that the state of the center pinching rollers 72 is maintained.

Subsequently, in step S111, as shown in FIG. 7, the cutting controller 94 controls the head moving mechanism 40, the medium moving mechanism 55, and the cutting head 30 such that the recording medium 5 is cut based on the control commands CM2 for the cutting data CD1 subsequent to the cutting start command CM32. In the cutting job, the first primary elevation controller 97 causes cutting to be performed on the recording medium 5 with the recording medium 5 sandwiched between the center pinching rollers 72 and the grit rollers 57.

Next, a case where the job type is the printing and cutting job will be described. In the printing and cutting job, the job data JD11 shown in FIG. 5 is executed. In step S101 of FIG. 6, the command executor 96 sequentially executes the job commands CM1 including the job type command CM11 in which the job type is set at the printing and cutting job. Accordingly, the storage 91 stores the basic setting information including information indicating that the job type is the printing and cutting job.

In this example, printing on the recording medium 5 as described below is performed between step S101 and step S103. As shown in FIG. 5, for example, the command executor 96 executes the printing start command CM31. Accordingly, the printer 100 recognizes that printing is performed on the recording medium 5, and performs a process concerning printing. In this example, the second elevation controller 99 controls the elevation mechanism 85 such that the center pinching rollers 72 and the grit rollers 57 sandwich the recording medium 5. Before the printing and cutting job is started, the center pinching rollers 72 have been lowered. Thus, the second elevation controller 99 controls the elevation mechanism 85 such that the state of the center pinching rollers 72 is maintained. Then, with the recording medium 5 sandwiched between the center pinching rollers 72 and the grit rollers 57, the printing controller 93 controls the head moving mechanism 40, the medium moving mechanism 55, and the ink heads 22 such that printing is performed on the recording medium 5 based on the control commands CM2 for the printing data PD1 subsequent to the printing start command CM31.

In this manner, after printing on the recording medium 5 is finished, in step S103 of FIG. 6, the command executor 96 executes the cutting start command CM32. Accordingly, the printer 100 recognizes that cutting is performed on the recording medium 5, and performs a process concerning cutting. In this example, since the job type is the printing and cutting job, the process of step S105 proceeds to YES, and step S109 is then performed.

In step S109, the first secondary elevation controller controls the elevation mechanism 85 such that the center pinching rollers 72 move upward and stay away from the grit rollers 57. In this example, at the end of printing, the center pinching rollers 72 have been lowered, and the center pinching rollers 72 and the grit rollers 57 sandwich the recording medium 5. Thus, the first secondary elevation controller 98 controls the elevation mechanism 85 so as to lift the center pinching rollers 72.

Subsequently, in step S111, as shown in FIG. 5, the cutting controller 94 controls the head moving mechanism 40, the medium moving mechanism 55, and the cutting head 30 such that the recording medium 5 is cut based on the control commands CM2 for the cutting data CD1 subsequent to the cutting start command CM32. In the printing and cutting job, the first secondary elevation controller 98 causes the center pinching rollers 72 to move upward and stay away from the grit rollers 57 so that the recording medium 5 is not sandwiched between the center pinching rollers 72 and the grit rollers 57. In this state, cutting is performed on the recording medium 5.

In this preferred embodiment, in the case where the job type is the printing job, control similar to that in printing in the printing and cutting job. That is, in the case where printing in the printing job is performed, the second elevation controller controls the elevation mechanism 85 such that the center pinching rollers 72 and the grit rollers 57 sandwich the recording medium 5.

As described above, in this preferred embodiment, the command executor 96 executes the job type command CM11 in which the job type is set so that a job type to be executed is able to be recognized before the job is started. In the case where the job type is the printing and cutting job, in performing cutting on the recording medium 5, the center pinching rollers 72 are controlled by the first secondary elevation controller 98 to move upward and stay away from the grit rollers 57. On the other hand, in the case where the job type is the cutting job, in performing cutting on the recording medium 5, the center pinching rollers 72 are controlled by the first primary elevation controller 97 such that the center pinching rollers 72 and the grit rollers 57 sandwich the recording medium 5. Thus, by executing the job type command CM11 in which the job type is set, the center pinching rollers 72 is automatically controlled such that the position of the center pinching rollers 72 in the vertical direction is different among the cases where different job types are executed even for the same process concerning cutting.

In this preferred embodiment, in the case of the cutting and printing job, the printed recording medium 5 is cut with the center pinching rollers 72 separated from the recording medium 5. Accordingly, the center pinching rollers 72 do not travel while being in contact with the printed upper surface of the recording medium 5, and thus, quality degradation of printing is reduced or prevented. On the other hand, in the case of the cutting job, the unprinted recording medium 5 is cut while being sandwiched between the center pinching rollers 72 and the grit rollers 57. Thus, in the cutting job, positional displacement of the recording medium 5 is able to be reduced or prevented.

In this preferred embodiment, as shown in FIG. 5, the cutting controller 94 performs control concerning cutting by sequentially executing the control commands CM2 (cutting control commands) for the cutting data CD1. Accordingly, the recording medium 5 is able to be appropriately cut based on the cutting data CD1.

In this preferred embodiment, in both of the printing job and the printing and cutting job, in a case where the command executor 96 executes the printing start command CM31, the second elevation controller 99 controls the elevation mechanism 85 such that the center pinching rollers 72 and the grit rollers 57 sandwich the recording medium 5. Accordingly, in printing, printing is performed on the recording medium 5 with the recording medium 5 sandwiched between the center pinching rollers 72 and the grit rollers 57. Thus, in printing, positional displacement of the recording medium 5 is able to be reduced or prevented.

In this preferred embodiment, the printing controller 93 performs control on printing by sequentially executing the control commands CM2 (printing control commands) for the printing data PD1. Accordingly, printing is appropriately performed on the recording medium 5 based on the printing data PD1.

In this preferred embodiment, the job data creator 164 of the job data creating device 150 acquires the basic setting information displayed on the display screen 151 and stored in the creation storage 162, and creates the job commands CM1. Based on the printing image data and the cutting image data displayed on the display screen 151 and stored in the creation storage 162, the job data creator 164 creates the printing data PD1 and the cutting data CD1, respectively, to create the control commands CM2. The job data creator 164 creates the execution commands CM3 located before and after the control commands CM2. Accordingly, the job data creator 164 creates the job data JD11 as shown in FIG. 5 and the job data JD12 as shown in FIG. 7. Thus, the operator is allowed to operate the operation device 152 and create the job data JD11 and JD12 using the basic setting information, the printing image data, and the cutting image data stored in the creation storage 162. Consequently, by operating the operation device 152, it is possible to easily create the job data JD11 and JD12 on different pieces of basic setting information, different pieces of printing image data, different pieces of cutting image data.

The foregoing description is directed to the preferred embodiments of the present disclosure. The preferred embodiments described above, however, are merely examples, and do not limit the present invention.

### Second Preferred Embodiment

A printer 100A according to a second preferred embodiment of the present invention will now be described. The printer 100A according to this preferred embodiment may be a printer with a cutting head similar to that of the first preferred embodiment or a printer not including the cutting head 30 illustrated in FIG. 1. The printer 100A according to the present preferred embodiment is a printer capable of performing overprinting. The “overprinting” here refers to, for example, printing in which a lower-layer image is formed on a recording medium 5 and an upper-layer image is formed on the lower-layer image. Here, the lower layer is an underlying layer onto which a white ink is discharged. The lower layer will be also referred to as an underlying layer. The upper layer is formed on the lower layer and is a layer onto which a process color ink is discharged. The upper layer will be also referred to as a main layer. In this preferred embodiment, printing of one layer on the recording medium 5 will be referred to as a “single-layer printing.” In the single-layer printing, only the main layer is printed, for example, but only the underlying layer may be printed. In this preferred embodiment, printing of the underlying layer corresponds to a “second process”, and printing of the main layer corresponds to a “first process”.

In overprinting, an underlying layer is first formed on the recording medium 5. At this time, while the recording medium 5 is conveyed in a direction X1 of sub-scanning directions X from a predetermined printing start position of the recording medium 5, printing of an underlying layer is performed on the recording medium 5. Then, after printing of the underlying layer is finished, the recording medium 5 is conveyed in a direction X2 of the sub-scanning directions X such that the recording medium 5 is located at the printing start position again. Thereafter, while the recording medium 5 is conveyed from the printing start position in the direction X1 of the sub-scanning directions X again, printing of a main layer is performed.

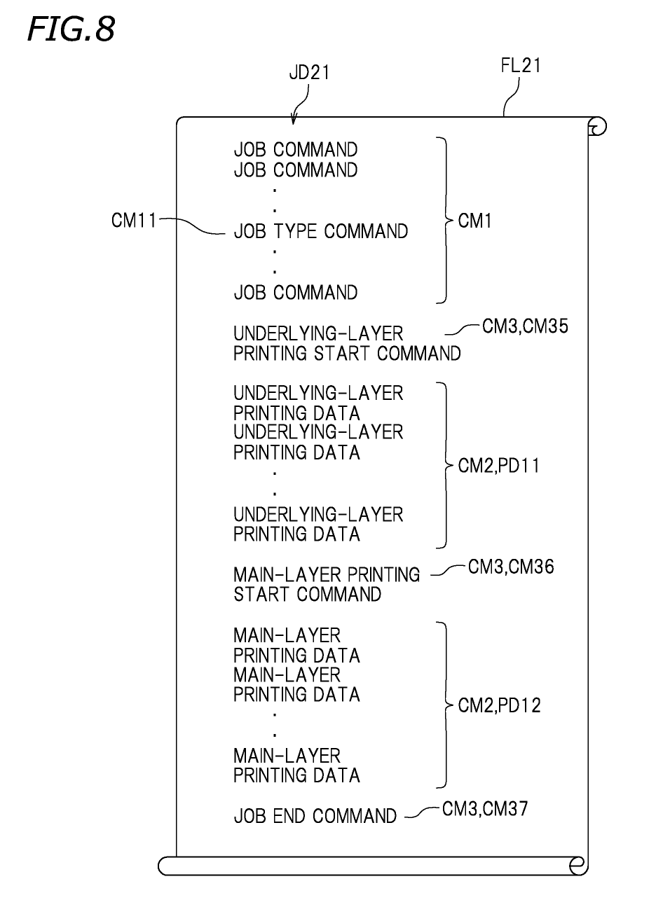

In this preferred embodiment, the job types include two jobs: a single-layer printing job in which a single-layer printing is performed and an overprinting job in which overprinting is performed. In this example, the single-layer printing job corresponds to a “first job type”, and the overprinting job corresponds to a “second job type”. FIG. 8 is a view showing an example of job data JD21 of the overprinting job. As shown in FIG. 8, the job data JD21 is stored in a job execution file FL21. The job data JD21 of the overprinting job includes job commands CM1 including a job type command CM11 in which the job type is set at the overprinting job, control commands CM2, and execution commands CM3. The control commands CM2 include a control command for underlying-layer printing data PD11 as printing data in underlying-layer printing, and a control command on main-layer printing data PD12 as printing data in main-layer printing.

The execution commands CM3 include an underlying-layer printing start command CM35 for a start of printing of the underlying layer, a main-layer printing start command CM36 for start of printing of the main layer, and a job end command CM37. The underlying-layer printing start command CM35 is a command specified before the control commands CM2 for the underlying-layer printing data PD11. The underlying-layer printing start command CM35 is an example of a “second process start command”. The main-layer printing start command CM36 is a command specified before the control command CM2 for the main-layer printing data PD12. The main-layer printing start command CM36 is an example of a “first process start command”.

In this preferred embodiment, the job data JD21 is also created by a job data creating device 150 similar to that of the first preferred embodiment.

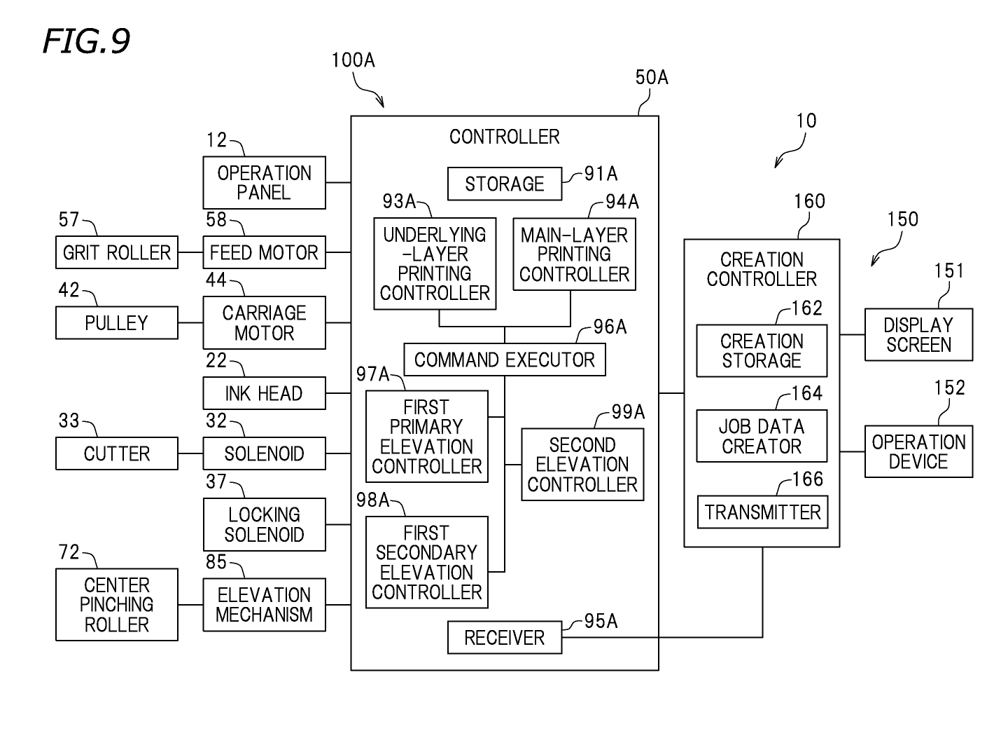

FIG. 9 is a block diagram of the printer 100A according to the present preferred embodiment. As shown in FIG. 9, the printer 100A includes a controller 50A. The controller 50A includes a storage 91A that stores at least the job data JD21 created by the job data creating device 150, an underlying-layer printing controller 93A, a main-layer printing controller 94A, a receiver 95A, a command executor 96A, a first primary elevation controller 97A, a first secondary elevation controller 98A, and a second elevation controller 99A. The receiver 95A receives the job data JD21 transmitted by a transmitter 166 of the job data creating device 150 and causes the storage 91A to store the job data JD21.

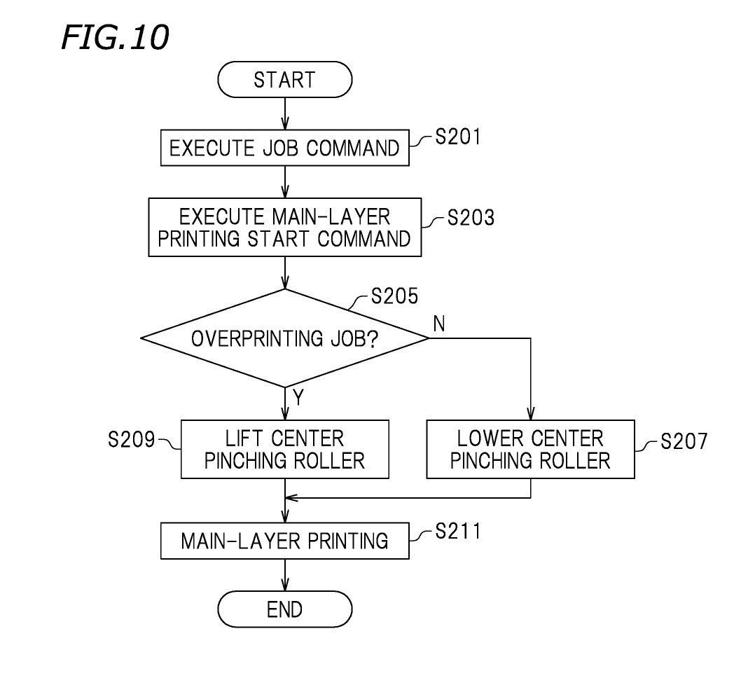

Next, description will be given on an operation in which control of the position of center pinching rollers 72 in the vertical direction in printing of a main layer on the recording medium 5 is different for different job types, with reference to the flowchart of FIG. 10.

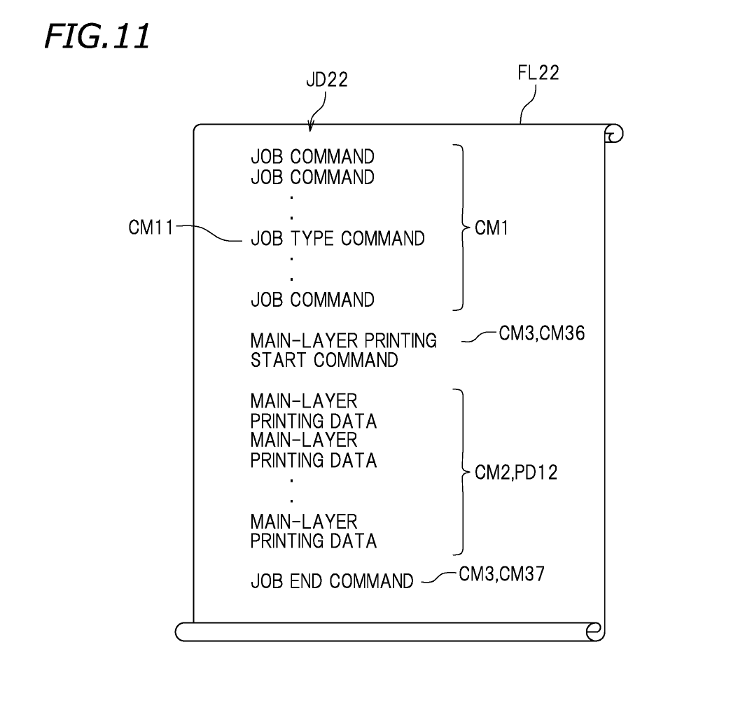

Here, a case where the job type is a single-layer printing job will be first described. FIG. 11 is a view showing an example of the job data JD22 for the single-layer printing job. As shown in FIG. 11, in the job data JD22 for the single-layer printing job, job commands CM1 including a job type command CM11 in which the job type is set at the single-layer printing job, a main-layer printing start command CM36 of the execution command CM3, control commands CM2 for a plurality of pieces of main-layer printing data PD12, and a job end command CM37 of the execution command CM3 are arranged in this order. The job data JD22 is stored in a job execution file FL22.

In executing the job data JD22 for the single-layer printing job, in step S201 of FIG. 10, the command executor 96A sequentially executes the job commands CM1. Accordingly, the storage 91A stores basic setting information including information indicating that the job type is the single-layer printing job.

Thereafter, in step S203, the command executor 96A executes the main-layer printing start command CM36. Accordingly, the printer 100A recognizes that printing of a main layer is performed on the recording medium 5 and performs a process concerning single-layer printing, that is, a process concerning printing of the main layer is performed. In this example, since the job type is the single-layer printing job, the process of step S205 proceeds to NO, and step S207 is then performed.

In step S207, the first primary elevation controller 97A controls an elevation mechanism 85 such that the center pinching rollers 72 and grit rollers 57 sandwich the recording medium 5. In this example, before the single-layer printing job is started, the center pinching rollers 72 have been lowered and the center pinching rollers 72 and the grit rollers 57 sandwich the recording medium 5. Thus, the first primary elevation controller 97A controls the elevation mechanism 85 such that the state of the center pinching rollers 72 is maintained.

Subsequently, in step S211, as shown in FIG. 11, the main-layer printing controller 94 controls the head moving mechanism 40, the medium moving mechanism 55, and the ink heads 22 such that a main layer is printed on the recording medium 5 based on the control commands CM2 for the main-layer printing data PD12 subsequent to the main-layer printing start command CM36. In the single-layer printing job, the first primary elevation controller 97A causes printing of a main layer to be performed on the recording medium 5 with the recording medium 5 sandwiched between the center pinching rollers 72 and the grit rollers 57.

A case where the job type is an overprinting job will now be described. In this example, the job data JD21 shown in FIG. 8 is executed. In step S201 of FIG. 10 in the overprinting job, in a manner similar to a case where the job type is the single-layer printing job, the command executor 96A sequentially executes the job commands CM1 including the job type command CM11 in which the job type is set at the overprinting job. Accordingly, the storage 91A stores basic setting information including information indicating that the type is overprinting.

In the overprinting job, printing of the underlying layer is performed on the recording medium 5 between step S201 and step S203. For example, as illustrated in FIG. 8, the command executor 96A executes the underlying-layer printing start command CM35. Accordingly, the printer 100A recognizes that printing of an underlying layer is performed on the recording medium 5, and performs a process concerning printing of an underlying layer. In this example, the second elevation controller 99A controls the elevation mechanism 85 such that the center pinching rollers 72 and the grit rollers 57 sandwich the recording medium 5. Before the overprinting job is started, the center pinching rollers 72 have been lowered. Thus, the second elevation controller 99A controls the elevation mechanism 85 such that the state of the center pinching rollers 72 is maintained. Thereafter, with the recording medium 5 sandwiched between the center pinching rollers and the grit rollers 57, the underlying-layer printing controller 93A controls the head moving mechanism 40, the medium moving mechanism 55, and the ink heads 22 such that printing of an underlying layer is performed on the recording medium 5 based on the control commands CM2 for the underlying-layer printing data PD11 subsequent to the underlying-layer printing start command CM35.

In the manner described above, after printing of the underlying layer is finished on the recording medium 5, in step S203 of FIG. 10, the command executor 96A executes the main-layer printing start command CM36. Accordingly, the printer 100A recognizes that printing of a main layer is performed on the recording medium 5, and performs a process concerning printing of a main layer. In this example, since the job type is the overprinting job, the process of step S205 proceeds to YES, and step S209 is then performed.

In step S209, the first secondary elevation controller 98A controls the elevation mechanism 85 such that the center pinching rollers 72 move upward and stay away from the grit rollers 57. In this example, at the end of printing of the underlying layer, the center pinching rollers 72 have been lowered, and the center pinching rollers 72 and the grit rollers 57 sandwich the recording medium 5. Thus, the first secondary elevation controller 98A controls the elevation mechanism 85 so as to lift the center pinching rollers 72.

Subsequently, in step S211, as shown in FIG. 8, the main-layer printing controller 94A controls the head moving mechanism 40, the medium moving mechanism 55, and the ink heads 22 such that a main layer is printed on the recording medium 5 based on the control commands CM2 for the main-layer printing PD12 subsequent to the main-layer printing start command CM36. In the overprinting job, in a state where the first secondary elevation controller 98A causes the center pinching rollers 72 to move upward and stay away from the grit rollers 57 so that the recording medium 5 is returned to the printing start position without contacting the center pinching rollers 72. Thereafter, with the center pinching rollers 72 and the grit rollers 57 separated from each other, printing of a main layer is performed on the recording medium 5.

As described above, in this preferred embodiment, in a case where the job type is the overprinting job and printing of a main layer is performed on the recording medium 5, the first secondary elevation controller 98A controls the center pinching rollers 72 such that the center pinching rollers 72 move upward and stay away from the grit rollers 57. On other hand, in a case where the job type is the single-layer printing job and printing of a main layer is performed, the center pinching rollers 72 are controlled by the first primary elevation controller 97A such that the center pinching rollers 72 and the grit rollers 57 sandwich the recording medium 5. Thus, by executing the job type command CM11 in which the job type is set, the center pinching rollers 72 is automatically controlled such that the position of the center pinching rollers 72 in the vertical direction is different among the cases where different job types are executed even for the same process concerning printing of a main layer.

In this preferred embodiment, in the overprinting job, to place priority on image quality, printing of a main layer is performed on the recording medium 5 on which an underlying layer has been printed with the center pinching rollers 72 being separated from the recording medium 5. Accordingly, the center pinching rollers 72 do not travel while being in contact with the underlying layer on the recording medium 5, and thus, quality degradation of the underlying layer is able to be reduced or prevented. On the other hand, in the single-layer printing job, printing of a main layer is performed on the recording medium 5 with the unprinted recording medium 5 sandwiched by the center pinching rollers 72 and the grit rollers 57. Thus, in the single-layer printing, positional displacement of the recording medium 5 is able to be reduced or prevented.

In the preferred embodiments described above, the job data JD11, JD12, JD21, and JD22 is created by the external job data creating device 150 connected to the printer 100, 100A. Alternatively, the job data JD11, JD12, JD21, and JD22 may be created by the controller 50, 50A of the printer 100, 100A.

Jobs other than the job types described in the preferred embodiments may be set as a job type. For example, a cutting and printing job may be set as a job type. That is, as the job type command CM11, the job type command CM11 in which the cutting and printing job is set may be used. The cutting and printing job is a job in which cutting is performed on the recording medium 5 and printing is performed on the recording medium 5 subjected to the cutting. For example, ink has been discharged onto the recording medium 5 subjected to printing, and this ink might cause the recording medium 5 to expand or contract. Here, execution of the cutting and printing job enables cutting of the recording medium 5 before printing. Thus, the recording medium 5 is able to be cut with minimum expansion and contraction of the recording medium 5 caused by ink. In the cutting and printing job, in cutting, a heater (not shown) disposed below the platen 16 is operating. Thus, in printing, to use the operating heater, a standby time before the heater reaches a predetermined time is able to be shortened. Thus, a throughput of printing is able to be enhanced.

As a job type, a printing, cutting, and perforation cutting job may be set. Specifically, as the job type command CM11, a job type command CM11 in which the printing, cutting, and perforation cutting job is set. The printing, cutting, and perforation cutting job is a job in which cutting along perforation is automatically performed on the recording medium 5 subjected to printing and cutting. This perforation cutting is different from the “cutting” described above, and is cutting along perforation, where the perforation is drawn to surround a printing region of the recording medium 5, for example. In a conventional technique, such perforation is implemented by an operator beforehand. However, execution of the job type command CM11 in which the printing, cutting, and perforation cutting job is set enables the printer to automatically draw perforation on the recording medium 5 subjected to printing and cutting without previous setting by the operator.

In preferred embodiments, each function of these elements of the controller 50, 50A of the printer 100, 100A and each function of these elements of the creation controller 160 of the job data creating device 150 may be implemented by software. That is, each function of these elements of the controller 50, 50A and each function of these elements of the creation controller 160 may be implemented by a computer incorporating a computer program. The present disclosure includes a computer program to cause a computer to function as each function of these elements of the controller 50, 50A and the creation controller 160. The present disclosure also includes a computer-readable recording medium in which the computer program is recorded. The present disclosure includes a circuit that achieves functions similar to programs executed by the functions of these elements of the controller 50, 50A and the functions of these elements of the creation controller 160.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A printer comprising;
a placing table on which a recording medium is placed;
an ink head that discharges ink onto the recording medium placed on the placing table;
a head moving mechanism that moves the ink head in a main scanning direction relative to the recording medium placed on the placing table;
a medium moving mechanism that moves the recording medium placed on the placing table in a sub-scanning direction relative to the ink head; and
a controller that controls the ink head, the head moving mechanism, and the medium moving mechanism; wherein
the medium moving mechanism includes:
a pair of side pinching rollers disposed above the placing table and presses end portions of the recording medium in the main scanning direction;
at least one center pinching roller that is disposed between the pair of side pinching rollers and presses the recording medium;
driving rollers that are arranged in the main scanning direction, are located below the pair of side pinching rollers and the center pinching roller, and move the recording medium in the sub-scanning direction while the recording medium is sandwiched between the driving rollers and the pair of side pinching rollers and between the driving rollers and the at least one center pinching roller; and
an elevation mechanism that lifts and lowers the at least one center pinching roller;
the controller includes a storage that stores job data that includes:
a job command to set basic setting information about printing; and
an execution command including at least a first process start command to start a first process on the recording medium;
the job command includes a job type command in which one job type is specified from job types including a first job type in which the first process is performed and a second process different from the first process is not performed, and a second job type in which the first process is performed after the second process is performed; and
the controller includes:
a command executor that executes the job command and the execution command;
a first primary elevation controller that controls the elevation mechanism such that the at least one center pinching roller stays down on the driving rollers to hold the recording medium in a case where the job type of the job type command when the job type command is executed by the command executor is the first job type and the first process start command is executed by the command executor; and
a first secondary elevation controller that controls the elevation mechanism such that the at least one center pinching roller moves upward and stays away from the driving rollers in a case where the job type of the job type command when the job type command is executed by the command executor is the second job type and the first process start command is executed by the command executor.

2. The printer according to claim 1, further comprising a cutting head that cuts the recording medium placed on the placing table, wherein
the head moving mechanism is configured to move the cutting head in the main scanning direction relative to the recording medium placed on the placing table;
the medium moving mechanism is configured to move the recording medium placed on the placing table in the sub-scanning direction relative to the cutting head;
the storage stores cutting data about the recording medium; and
the first process is a process to control the head moving mechanism, the medium moving mechanism, and the cutting head such that the recording medium is cut based on the cutting data.

3. The printer according to claim 2, wherein the controller includes a cutting controller that controls the first process either while the first primary elevation controller causes the at least one center pinching roller and the driving rollers to stay down on the recording medium or while the first secondary elevation controller causes the at least one center pinching roller to move upward and stay away from the driving rollers.

4. The printer according to claim 3, wherein
the job data includes a cutting control command to specify the cutting data in cutting; and
the cutting controller executes the cutting control command to control the first process.

5. The printer according to claim 1, wherein
the execution command includes a second process start command to start the second process; and
the controller includes a second elevation controller that controls the elevation mechanism such that the center pinching roller stays down on the driving rollers to hold the recording medium in a case where the job type of the job type command when the job type command is executed by the command executor is the second job type and the second process start command is executed by the command executor.

6. The printer according to claim 5, wherein
the job type includes a third job type in which the first process is not executed and the second process is executed; and
the second elevation controller controls the elevation mechanism such that the at least one center pinching roller stays down on the driving rollers to hold the recording medium in a case where the job type of the job type command when the job type command is executed by the command executor is the third job type and the second process start command is executed by the command executor.

7. The printer according to claim 5, wherein
the storage stores printing data about the recording medium; and
the second process is a process in which the head moving mechanism, the medium moving mechanism, and the ink head are controlled such that printing is performed on the recording medium based on the printing data.

8. The printer according to claim 7, wherein the controller includes a printing controller that controls the second process while the second elevation controller causes the center pinching roller stays down on the driving rollers to hold the recording medium.

9. The printer according to claim 8, wherein
the job data includes a printing control command that is a command to specify the print data in printing; and
the printing controller executes the printing control command to control the second process.

10. A printing system comprising:
the printer according to claim 1; and
a job data creating device that creates the job data; wherein
the job data creating device includes:
a display screen that displays at least the basic setting information;
an operation device on which the basic setting information displayed on the display screen is set by an operator; and
a creation controller communicably connected to the controller of the printer;
the creation controller includes:
a creation storage that stores the basic setting information displayed on the display screen and operated by the operation device;
a job data creator that acquires the basic setting information stored in the creation storage to create the job command and creates the execution command located subsequent to the job command to create the job data; and
a transmitter that transmits the job data created by the job data creator to the controller; and
the controller receives the job data transmitted from the transmitter and causes the storage stored in the job data.
